(19) United States
(12) Patent Application Publication
(10) Pub. No.: US 2023/0143683 A1
(43) Pub. Date: May 11, 2023

(54) METHOD AND APPARATUS FOR PROVIDING HUMAN-MACHINE-INTERFACE MODE OF VEHICLE

(71) Applicants: HYUNDAI MOTOR COMPANY, Seoul (KR); Kia Corporation, Seoul (KR)

(72) Inventors: Jung Seok SUH, Yongin-si (KR); Ja Yoon KOO, Anyang-si (KR)

(73) Assignees: HYUNDAI MOTOR COMPANY, Seoul (KR); Kia Corporation, Seoul (KR)

(21) Appl. No.: 17/738,128

(22) Filed: May 6, 2022

(30) Foreign Application Priority Data
Nov. 11, 2021 (KR) 10-2021-0155174

(51) Int. Cl. B60W 50/08; B60W 50/14

(52) U.S. Cl. CPC B60W 50/082; B60W 50/14; B60W 60/005

(57) ABSTRACT

A method and apparatus for providing a human-machine interface (HMI) mode of a vehicle are provided. The method, performed by the device of the vehicle, for providing a human-machine interface (HMI) mode includes, analyzing a state of an occupant, calculating a confidence score for the vehicle based on the state of the occupant, determining an HMI mode corresponding to the confidence score among a plurality of predefined HMI modes; and providing first guidance information to the occupant based on the determined HMI mode.

### CROSS-REFERENCE TO RELATED APPLICATION

The present application is based on and claims the benefit of priority to Korean Patent Application Number 10-2021-0155174, filed on Nov. 11, 2021 in the Korean Intellectual Property Office, the entire disclosure of which is incorporated herein by reference.

### TECHNICAL FIELD

The present disclosure relates to a method and an apparatus for providing a human-machine-interface (HMI) mode of a vehicle. More specifically, the present disclosure relates to a method and an apparatus capable of changing a guidance level provided by an HMI based on a confidence level of an occupant for an autonomous vehicle.

### BACKGROUND

The information disclosed below in the Background section is to aid in the understanding of the background of the present disclosure, and should not be taken as acknowledgement that this information forms any part of prior art.

Recently, research on autonomous vehicles has been actively conducted.

It is important that autonomous vehicle technology enables occupants to have confidence in autonomous vehicles. To this end, autonomous vehicles use a human-machine-interface (HMI) to guide occupants on a current driving situation and actions to be subsequently performed.

However, autonomous vehicles that are currently under development only provide guidance at a level preset by manufacturers. Accordingly, when a guidance level provided by a vehicle is less detailed than a guidance level desired by an occupant, it is difficult for the occupant to have confidence in autonomous vehicles. On the contrary, when a guidance level provided by a vehicle is excessively more detailed than a guidance level desired by an occupant, there is a problem in that the occupant may be distracted from concentrating on other tasks (such as sleeping, talking, using a cell phone, and watching media).

### SUMMARY

The present disclosure provides a method and an apparatus for providing a human-machine-interface (HMI) mode suitable for a confidence level of an occupant for an autonomous vehicle to secure an occupant's confidence in the autonomous vehicle without disturbing an occupant's concentration.

According to at least one aspect, the present disclosure provides a method, performed by a device of vehicle, for providing an HMI mode. The method includes analyzing a state of an occupant, calculating a confidence score for the vehicle based on the state of the occupant, determining an HMI mode corresponding to the confidence score among a plurality of predefined HMI modes; and providing first guidance information to the occupant based on the determined HMI mode.

According to another aspect, the present disclosure provides a device for providing an HMI mode including controller. The controller is configured to analyze a state of an occupant, to calculate a confidence score of the occupant for a vehicle based on the state of the occupant, to determine an HMI mode corresponding to the confidence score among a plurality of predefined HMI modes, and to provide first guidance information to the occupant based on the determined HMI mode.

According to yet another aspect, the present disclosure provides a vehicle for providing an HMI mode comprising a controller. The controller is configured to analyze a state of an occupant, to calculate a confidence score of the occupant for the vehicle based on the state of the occupant, to determine an HMI mode corresponding to the confidence score among a plurality of predefined HMI modes, and to provide first guidance information to the occupant based on the determined HMI mode.

As described above, according to embodiments of the present disclosure, by providing a HMI mode suitable for a confidence level of an occupant for an autonomous vehicle, an occupant's confidence in the autonomous vehicle can be secured without disturbing an occupant's concentration.

### BRIEF DESCRIPTION OF THE DRAWINGS

FIG. 1 is a block diagram illustrating a related configuration for providing a human-machine-interface (HMI) mode according to an exemplary embodiment of the present disclosure.

FIG. 2 is a diagram illustrating an example of an operation in which a device for providing an HMI mode determines an HMI mode based on a state of an occupant according to an exemplary embodiment of the present disclosure.

FIG. 3 is a flowchart illustrating a method for providing an HMI mode according to an exemplary embodiment of the present disclosure.

FIG. 4 is a flowchart illustrating a method for updating a confidence score based on a state of an occupant according to an exemplary embodiment of the present disclosure.

FIG. 5 is a flowchart illustrating a method for giving an initial confidence score to an occupant according to an exemplary embodiment of the present disclosure.

### DETAILED DESCRIPTION

Hereinafter, some embodiments of the present disclosure will be described in detail with reference to the exemplary drawings. In giving reference numerals to components of the drawings, the same reference numerals are given to the same components even though the same components are shown in different drawings. In addition, in the following description of the present disclosure, detailed descriptions of known functions and components incorporated herein will be omitted in the case that the subject matter of the present disclosure may be rendered unclear thereby.

Terms such as “first,” “second,” “A,” “B,” “(a),” and “(B)” may be used herein to describe components of the present disclosure. Such terms are merely used to distinguish one component from another component. The substance, sequence, or order of these components is not limited by these terms. Throughout the specification, unless explicitly described to the contrary, the word “comprise” and variations such as “comprises” or “comprising” will be understood to imply the inclusion of stated components but not the exclusion of any other components. In addition, the terms “unit” and “module” described in the specification mean units for processing at least one function and operation and can be implemented by hardware components or software components and combinations thereof.

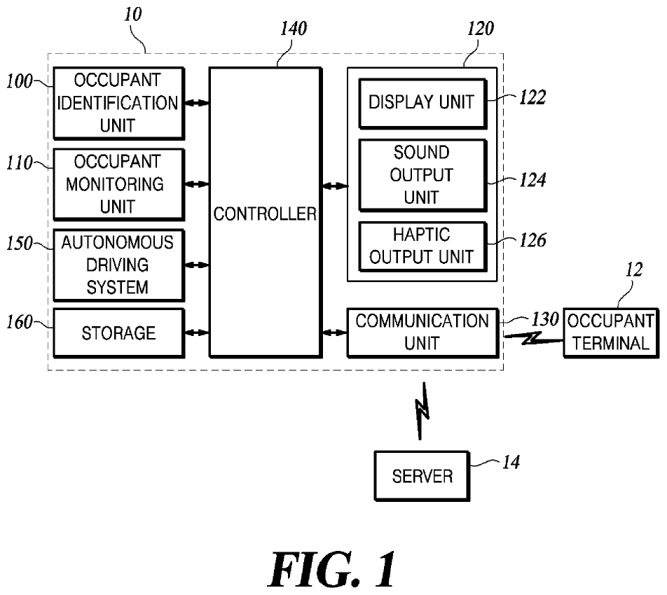

FIG. 1 is a block diagram illustrating a related configuration for providing a human-machine-interface (HMI) mode according to an exemplary embodiment of the present disclosure.

A vehicle 10 may be configured to determine an HMI mode corresponding to a confidence level of an occupant for the vehicle among a plurality of predefined HMI modes and provides guidance information about the vehicle 10 to an occupant according to the determined HMI mode. The HMI mode may be classified into a maximum guidance mode, an intermediate guidance mode, and a minimum guidance mode according to a guidance level. The maximum guidance mode, the intermediate guidance mode, and the minimum guidance mode may respectively correspond to states indicating the occupant's confidence level about vehicle lower to higher. In addition, the HMI mode may be classified into two or more modes according to various criteria.

The vehicle 10 may be configured to provide an autonomous driving function. In this case, the guidance information about the vehicle 10 may include guidance information about a driving situation of the vehicle 10 or a behavior to be subsequently performed by the vehicle 10.

Referring to FIG. 1, the vehicle 10 may include all or some of an occupant identification unit 100, an occupant monitoring unit 110, an output unit 120, a communication unit 130, a controller 140, an autonomous driving system 150, and a storage 160. Each component may be a device or logic mounted on the vehicle 10. Not all of the blocks shown in FIG. 1 are essential components, and some blocks included in the vehicle 10 may be added, changed, or deleted in other embodiments.

Each of the components may exchange signals through an internal communication system (not shown). The signal may include data. The internal communication system may use at least one communication protocol (for example, CAN, LIN, FlexRay, MOST, or Ethernet).

A device for providing an HMI mode according to one embodiment of the present disclosure may include at least one of a device and logic mounted on the vehicle 10. For example, the device for providing an HMI mode may include the controller 140 and the storage 160. In another embodiment, a function of the device for providing an HMI mode may be implemented by being integrated into the autonomous driving system 150.

The occupant identification unit 100 may be configured to acquire identification information for identifying an occupant of the vehicle 10. According to some exemplary embodiments, the identification information may include at least one of face information, iris information, fingerprint information, or voice information. To this end, the occupant identification unit 100 may include at least one of a face recognition sensor, an iris recognition sensor, a fingerprint recognition sensor, or a microphone.

The occupant monitoring unit 110 may be configured to acquire occupant information about a behavior or state of an occupant inside the vehicle 10. Here, the occupant information may include a captured image of an occupant, a voice of the occupant, and/or biometric information (for example, a heart rate) of the occupant. The occupant monitoring unit 110 may be implemented as at least one of a camera for photographing the interior of the vehicle 10, a microphone for receiving the voice of the occupant, or various sensing devices capable of sensing the biometric information of the occupant.

The output unit 120, which is an HMI between the vehicle 10 and the occupant, may be configure to provide information about the vehicle 10 to the occupant. The output unit 120 may include all or some of a display unit 122, a sound output unit 124, and a haptic output unit 126.

The display unit 122 may provide information about the vehicle 10 to the occupant using a graphic user interface (GUI). The display unit 122 may be implemented to include a display disposed in one area of the vehicle 10, e.g., a seat, an audio video navigation (AVN), a head up display (HUD), and/or a cluster. The display unit 122 may be implemented as a touch display.

The sound output unit 124 may provide the information about the vehicle 10 to the occupant using an auditory user interface (AUI). The sound output unit 124 may be implemented as a speaker that outputs a voice, a notification sound, and/or the like.

The haptic output unit 126 may provide the information about the vehicle 10 to the occupant using a physical user interface (PUI). The haptic output unit 126 may be implemented as a vibration module provided in a steering wheel, a seat belt, and/or a seat.

The communication unit 130 may be configured to communicate with an external device of the vehicle 10. According to some exemplary embodiments, the communication unit 130 may be configured to communicate with an occupant terminal 12 and/or an external server 14 using a wired/wireless communication manner. Here, the occupant terminal 12 is a device carried by an occupant of the vehicle 10. The occupant terminal 12 may be, for example, a mobile device such as a smart phone, a smart watch, or a tablet personal computer.

The communication unit 130 may be configured to receive identification information from the occupant terminal 12. Here, the identification information may be an ID number or a digital key assigned to an occupant but is not limited thereto, and the identification information may include any type of information capable of identifying an occupant.

The communication unit 130 may be configured to receive one or more pieces of personal information for comparison with the identification information from the server 14.

The communication unit 130 may be configured to transmit an HMI mode corresponding to an occupant's confidence level, guidance information to be provided to an occupant, and/or a signal for causing the occupant terminal 12 to operate in a preset manner to the occupant terminal 12. For example, the communication unit 130 may be configured to transmit a signal, which causes the occupant terminal 12 to generate a vibration, to the occupant terminal.

As such, the vehicle 10 may visually, auditorily, and/or tactically interact with an occupant by using at least one of the output unit 120 or the occupant terminal 12.

The controller 140 may be configured to perform calculation and control related to the provision of an HMI mode in cooperation with at least one of the occupant identification unit 100, the occupant monitoring unit 110, the output unit 120, the communication unit 130, or the storage 160. The controller 140 may include one or more processors, for example, an electronic control unit (ECU), a micro controller unit (MCU), or other sub-controllers which are mounted on a vehicle.

The control unit 140 may be configured to calculate a confidence level of an occupant for the vehicle 10, may be configured to determine an HMI mode corresponding to the confidence level of the occupant from among a plurality of predefined HMI modes, and may be configured to provide guidance information to the occupant according to the determined HMI mode.

The control unit 140 may be configured to identify an occupant based on identification information acquired from the occupant identification unit 100 and/or the occupant terminal 12. Here, the occupant terminal 12 may be present outside the vehicle or inside the vehicle. For example, when an occupant boards the vehicle 10 or calls the vehicle 10 outside the vehicle 10, the controller 140 may be configured to acquire identification information from the occupant terminal 12 through the communication unit 130.

The controller 140 may be configured to identify an occupant by comparing the identification information with personal information for each of the one or more occupants prestored in the storage 160 or the server 14. More specifically, the controller 140 may be configured to identify an occupant by retrieving personal information that matches identification information acquired from the occupant identification unit 100 and/or the occupant terminal 12 among one or more pieces of personal information for each of the one or more occupant prestored in the storage 160 or the server 14. For example, the storage 160 may be configured to prestore face information for each occupant, and the controller 140 may be configured to identify an occupant by retrieving information that matches face information captured by the occupant identification unit 100 among pieces of face information stored in the storage 160.

Meanwhile, in response to determining that personal information that matches identification information is not retrieved in the storage 160 and/or the server 14, the controller 140 may be configured to determine that an occupant boards the vehicle 10 for the first time. The controller 140 may be configured to store identification information of the occupant who boards the vehicle 10 for the first time as personal information about the corresponding occupant in the storage 160 and/or the server 14.

The controller 140 may be configured to analyze a state of an occupant based on occupant information acquired from the occupant monitoring unit 110. Here, the state of the occupant may relate to a gaze and/or action of the occupant.

The controller 140 may be configured to analyze the gaze of the occupant based on the occupant information acquired from the occupant monitoring unit 110. For example, the controller 140 may be configured to determine whether an occupant gazes outside the vehicle 10, such as gazing in a front direction or a lateral direction of the vehicle 10, based on a captured image of the occupant.

The controller 140 may be configured to analyze the action of the occupant based on the occupant information acquired from the occupant monitoring unit 110. For example, the controller 140 may be configured to determine whether an occupant is sleeping, talking, reading a book, and/or watching a movie based on the captured image of the occupant. As another example, the controller 140 may be configured to determine whether an occupant is curious about a driving situation of the vehicle 10 based on the captured image of the occupant and/or a voice of the occupant.

According to some exemplary embodiments, the controller 140 may be configured to analyze a state of an occupant at a preset period or analyze the state of the occupant every time guidance information is provided.

The controller 140 may be configured to calculate an occupant's confidence score for the vehicle 10 based on a state of an occupant. According to some exemplary embodiments, a confidence score may be calculated based on at least one of whether guidance information is provided to an occupant, a state of the occupant analyzed at a time at which the guidance information is provided to the occupant, or an HMI mode corresponding to the guidance information provided to the occupant.

The controller 140 may be configured to give an initial confidence score to an occupant in response to the occupant boarding the vehicle 10, to the occupant callings the vehicle 10, and/or to the vehicle 10 starting driving. The controller 140 may be configured to update a confidence score based on a state of the occupant. Here, the initial confidence score may be a confidence score that is mapped with personal information of a corresponding occupant and is stored in the server 14 and/or the storage 160. Meanwhile, when an occupant boards the vehicle 10 for the first time, a preset initial confidence score (for example, 50 points) may be given.

According to some exemplary embodiment, the controller 140 may be configured to increase or decrease a confidence score based on a state of an occupant. For example, in response to the occupant gazing outside or in response to the occupant expressing curiosity about a driving situation of the vehicle 10, the controller 140 may be configured to increase a confidence score. On the contrary, in response to the occupant not gazing outside or in response to the occupant performing a task (for example, is sleeping, talking, using a mobile phone, and watching media), the controller 140 may be configured to decrease the confidence score.

According to some exemplary embodiments, the controller 140 may be configured to increase or decrease a confidence score based on a state of an occupant following the provision of guidance information. For example, in response to the occupant performing a task or not gazing outside even though guidance information is provided, the controller 140 may be configured to increase the confidence score. In response to the occupant gazing outside or expressing curiosity about a driving situation even though the guidance information is not provided to the occupant, the controller 140 may be configured to decrease the confidence score.

According to some exemplary embodiments, the controller 140 may be configured to increase or decrease the confidence score based on a state of an occupant and a guidance level of the provided guidance information, that is, an HMI mode.

Table 1 shows an example in which a confidence score is changed according to an HMI mode and a state of an occupant.

TABLE 1

| | | Change in |
|---|---|---|
| | | confidence |
| Guidance level | State of occupant | score |
| Provision of guidance | Gazing outside/Expression | 0 |
| information in | of curiosity | |
| maximum/intermediate | No gazing | +1 |
| guidance mode | outside/Performing task | |
| Provision of guidance | Gazing outside/Expression | −1 |
| information in minimum | of curiosity | |
| guidance mode | No gazing | 0 |
| | outside/Performing task | |

For example, in response to the occupant performing a task or not gazing outside even though the guidance information is provided to the occupant in the maximum guidance mode or the intermediate guidance mode, the confidence score may be increased. On the other hand, in response to the occupant gazes outside or expressing curiosity about a driving situation as the guidance information is provided to the occupant in the maximum guidance mode or the intermediate guidance mode, the confidence score may not be changed.

As another example, in response to the occupant gazing outside or expressing curiosity about a driving situation even though the guidance information is provided in the minimum guidance mode, the confidence score may be decreased. On the other hand, in response to the occupant performing a task or not gazing outside as the guidance information is provided to the occupant in the minimum guidance mode, the confidence score may not be changed.

Meanwhile, according to other exemplary embodiments of the present disclosure, the controller 140 may be configured to change a weight by which a confidence score is increased or decreased according to an HMI mode. For example, in response to an occupant gazing outside or expressing curiosity about a driving situation after guidance information is provided to the occupant in a maximum guidance mode or an intermediate guidance mode, the confidence score may be decreased by one. In response to the occupant performing a task or not gazing outside after the guidance information is provided to the occupant in the maximum guidance mode or an intermediate guidance mode, the confidence score may be increased by two. Similarly, in response to the occupant gazing outside or expressing curiosity about a driving situation after the guidance information is provided to the occupant in a minimum guidance mode, the confidence score may be decreased by two. In response to the occupant performing a task or not gazing outside after the guidance information is provided to the occupant in the minimum guidance mode, the confidence score may be increased by one.

The controller 140 may be configured to determine an HMI mode corresponding to an occupant's confidence score among a plurality of HMI modes. The controller 140 may be configured to determine the HMI mode corresponding to an occupant's confidence score based on a correlation between the occupant's confidence score and the HMI mode.

Table 2 shows an example of a correlation between an occupant's confidence score and an HMI mode.

TABLE 2

| Confidence score | Section | HMI mode |
|---|---|---|
| 0 to 33 | Confidence shortage | Maximum guidance mode |
| 34 to 66 | Confidence-forming | Intermediate guidance mode |
| 67 to 100 | Confidence secured | Minimum guidance mode |

Referring to Table 2, the correlation between the occupant's confidence score and the HMI mode may be defined such that, as the occupant's confidence score becomes higher, guidance provided to an occupant is minimized.

According to some exemplary embodiments, an HMI mode may be a maximum guidance mode, an intermediate guidance mode, or a minimum guidance mode. Here, the maximum guidance mode may correspond to a confidence score which is less than or equal to a preset first threshold, the intermediate guidance mode may correspond to the confidence score which is greater than the first threshold and less than or equal to a second preset threshold, and the minimum guidance mode may correspond to the confidence score which is greater than the second threshold.

The controller 140 may be configured to classify a confidence score as one of two or more sections based on a preset threshold and may be configured to provide an HMI mode corresponding to a corresponding section to an occupant. For example, in response to determining that a confidence score is less than or equal to the first threshold (for example, 33 points), the confidence score may be classified as a confidence shortage section, and thus, an HMI mode may be determined as a maximum guidance mode. In response to determining that a confidence score is greater than the first threshold and less than or equal to the second threshold (for example, 66 points), the confidence score may be classified as a confidence-forming section, and thus, an HMI mode may be determined as an intermediate guidance mode. In response to determining that a confidence score is greater than the second threshold, the confidence score may be classified as a confidence-secured section, and thus, an HMI mode may be determined as a minimum guidance mode.

The controller 140 may be configured to provide guidance information to an occupant based on the determined HMI mode.

The controller 140 may be configured to provide the guidance information to the occupant using at least one medium of an AUI, GUI, or a PUI. The controller 140 may be configured to control the output unit 120 to output guidance information corresponding to the determined HMI mode. The controller 140 may be configured to transmit information for instructing the output of the guidance information corresponding to the determined HMI mode to the occupant terminal 12 using the communication unit 130.

According to some exemplary embodiments, the controller 140 may be configured to change the type and/or number of media used to provide guidance information to an occupant for each HMI mode. For example, when an HMI mode is a maximum guidance mode, the controller 140 may be configured to provide guidance information to an occupant using a GUI, an AUI, and a PUI. When an HMI mode is an intermediate guidance mode, the controller 140 may be configured to provide guidance information to an occupant using a GUI and an AUI. When an HMI mode is a minimum guidance mode, the controller 140 may be configured to provide guidance information to an occupant using only a GUI.

According to some exemplary embodiments, the controller 140 may be configured to change an amount of information included in guidance information or a frequency at which the guidance information is provided for each HMI mode. For example, in response to determining that an HMI mode corresponding to an occupant's confidence score is a maximum guidance mode, the controller 140 may be configured to provide detailed guidance information to the occupant. In response to determining that the HMI mode corresponding to the occupant's confidence score is an intermediate guidance mode, the controller 140 may provide brief guidance information to the occupant. In response to determining that the HMI mode corresponding to the occupant's confidence score is a minimum guidance mode, the controller 140 may not provide guidance information to the occupant.

In response to an occupant getting out, the controller 140 may be configured to map HMI mode information of an occupant to personal information of the occupant and may be configured to store the HMI mode information in the storage 160 and/or the server 14. Here, the HMI mode information of the occupant may include an occupant's confidence score, a provided HMI mode, and/or a change history of the HMI mode.

The storage 160 stores various programs and data for providing an HMI mode according to one embodiment of the present disclosure. For example, the storage 160 may be configured to store a program for the controller 430 to provide an HMI mode. When the program is executed by the controller 140, the controller may be configured to perform the functions/operations described in the present disclosure and/or to cause other components to perform the respective functions/operations. The storage 160 may be configured to store personal information and/or HMI mode information for each occupant. The storage 160 may be configured to store a correlation between an occupant's confidence score and an HMI mode.

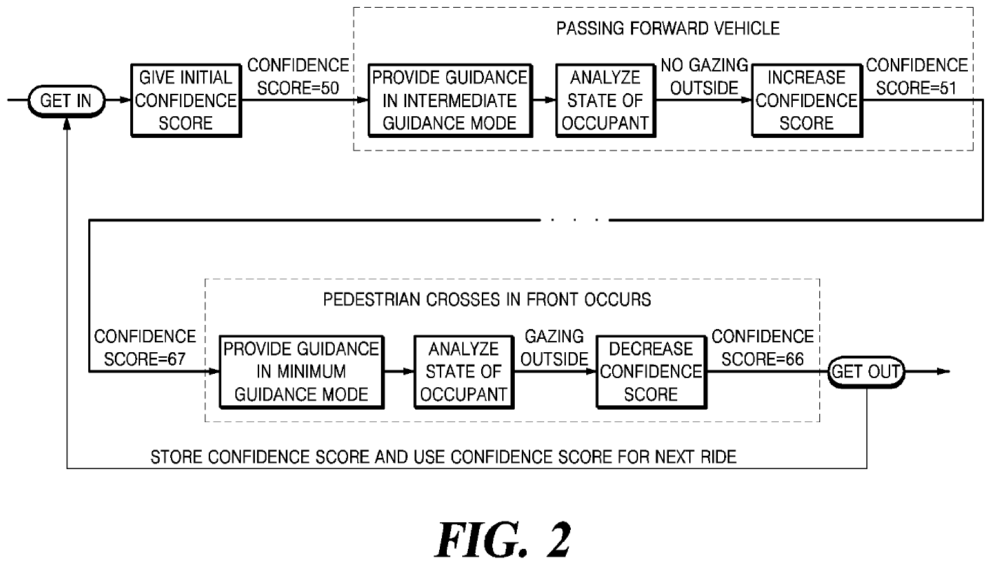

FIG. 2 is a diagram illustrating an example of an operation in which the device for providing an HMI mode determines an HMI mode based on a state of an occupant according to an exemplary embodiment of the present disclosure.

In response to an occupant getting in the vehicle 10, the device for providing an HMI mode gives an initial confidence score to the occupant. In response to the occupant getting in the vehicle 10 for the first time, the device for providing an HMI mode may be configured to give a preset initial confidence score (for example, 50 points) to the occupant, and accordingly, an HMI mode may be configured to be determined as an intermediate guidance mode.

In response to determining that a situation occurs in which the vehicle 10 should pass a forward vehicle during driving in the intermediate guidance mode, the device for providing an HMI mode provides guidance information according to the intermediate guidance mode to the occupant. A guidance information providing scheme according to the intermediate guidance mode may be predefined by a manufacturer.

In response to the occupant not gazing outside and/or continuingly performing his/her task (for example, uses a mobile phone) even though the guidance information is provided to the occupant in the intermediate guidance mode, the device for providing an HMI mode increases the occupant's confidence score.

Through such a series of processes, in response to determining that the occupant's confidence score is greater than a preset second threshold (for example, 66 points), the device for providing an HMI mode changes the HMI mode from the intermediate guidance mode to a minimum guidance mode.

In response to determining that a situation occurs in which a pedestrian crosses in front of the vehicle 10 and thus the vehicle 10 should be decelerated and/or stopped during driving in the minimum guidance mode, the device for providing an HMI mode provides guidance information according to the minimum guidance mode to the occupant. A guidance information providing scheme according to the minimum guidance mode may be predefined by a manufacturer, and according to some exemplary embodiments, the guidance information may not be provided.

In response to the occupant stopping a task that has been performed by himself or herself, for a reason such as being curious about why the vehicle 10 is decelerated and/or stopped, and/or then gazing outside the vehicle 10 even though the guidance information is provided to the occupant in the minimum guidance mode, the device for providing an HMI mode decreases the occupant's confidence score.

Accordingly, in response to determining that the occupant's confidence score is less than or equal to the second preset threshold, the device for providing an HMI mode changes the HMI mode from the minimum guidance mode to the intermediate guidance mode and provides guidance information according to the intermediate guidance mode when a next event occurs.

In response to the occupant getting out of the vehicle 10, the device for providing an HMI mode may be configured to store the occupant's confidence score and may be configured to use the occupant's confidence score as an initial confidence score when the occupant gets in again in the future.

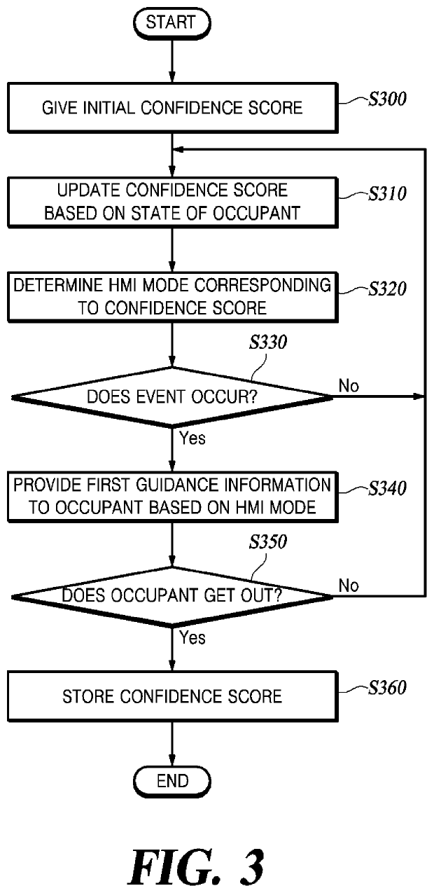

FIG. 3 is a flowchart illustrating a method for providing an HMI mode according to an exemplary embodiment of the present disclosure.

The method shown in FIGS. 3 to 5 may be performed by the device for providing an HMI mode, controller 140 and/or vehicle 10 described above with reference to FIGS. 1 and 2, and thus a redundant description thereof will be omitted.

The device for providing an HMI mode gives an initial confidence score to an occupant (S300).

The device for providing an HMI mode updates an occupant's confidence score based on a state of the occupant (S310).

The device for providing an HMI mode determines an HMI mode corresponding to the occupant's confidence score among a plurality of predefined HMI modes (S320).

The device for providing an HMI mode checks whether an event requiring the provision of guidance information has occurred (S330). For example, the device for providing an HMI mode may receive event information from an autonomous driving system 150 mounted on a vehicle 10 or may directly detect an event occurring during driving of the vehicle 10 based on an image acquired from a camera (not shown), that captures the outside of the vehicle 10, a driving path of the vehicle 10, and the like.

In response to the occurrence of the event, the device for providing an HMI mode provides first guidance information to the occupant based on the determined HMI mode (S330).

The device for providing an HMI mode may be configured to continuously update the confidence score by repeating operations S300 to S330 until the occupant gets out.

In response to the occupant getting out of the vehicle 10, the device for providing an HMI mode stores the occupant's confidence score (S350). The confidence score may be used as an initial confidence score when the occupant gets in again.

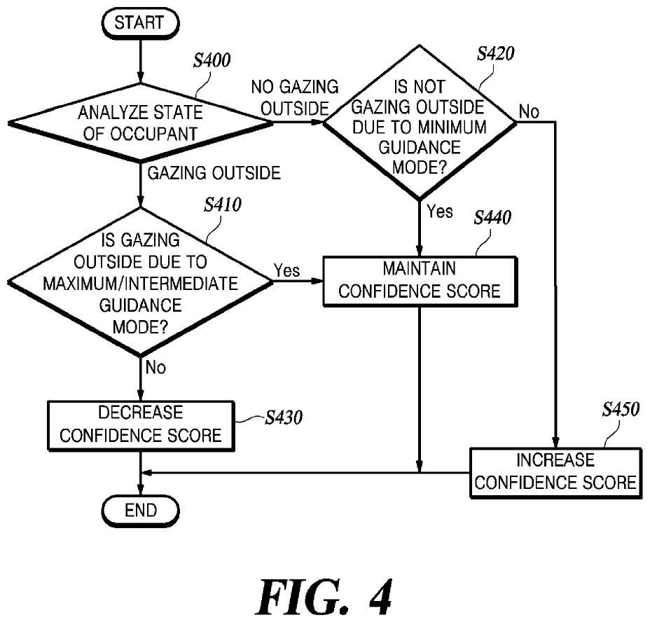

FIG. 4 is a flowchart illustrating a method for updating a confidence score based on a state of an occupant according to an exemplary embodiment of the present disclosure.

The device for providing an HMI mode analyzes the state of the occupant based on occupant information acquired from an occupant monitoring unit 110 (S400). Here, the state of the occupant may relate to a gaze and/or action of the occupant.

In response to the occupant gazing outside as second guidance information is provided to the occupant in a maximum guidance mode or an intermediate guidance mode (S410, YES), the device for providing an HMI mode maintains an existing confidence score (S440).

In response to the occupant stopping a task that has been performed and/or gazing outside even though the second guidance information is provided to the occupant in a minimum guidance mode (S410, NO), the device for providing an HMI mode decreases a confidence score (S430). According to some exemplary embodiments, in response to the occupant being curious about a driving situation of the vehicle 10 and/or gazing outside the vehicle 10 even though an event in which guidance information is provided does not occur and thus no guidance information is provided (S410, NO), the device for providing an HMI mode may be configured to decrease the confidence score (S430).

In response to the occupant not gazing outside as the second guidance information is provided to the occupant in the minimum guidance mode (S420, YES), the devices for providing an HMI mode maintains the existing confidence score (S440).

In response to the occupant not gazing outside and/or concentrating on a task that has been executed by himself or herself even though the second guidance information is provided to the occupant in the maximum guidance mode or the intermediate mode (S420, NO), the device for providing an HMI mode increases the confidence score (S450). According to some exemplary embodiments, in response to the occupant concentrating on a task for a preset time or more and being not curious about a driving condition of the vehicle 10 as an event in which guidance information is provided does not occur and thus no second guidance information is provided, the device for providing an HMI mode may be configured to increase the confidence score.

As described above, the device for providing an HMI mode may be configured to update the confidence score according to the state of the occupant. Based on this, in response to an occupant being curious about a driving situation or taking action to carefully look at the outside of the vehicle 10, a confidence score of the corresponding occupant may become a score corresponding to a confidence shortage section, and guidance information may be provided in a direction in which a confidence can be secured. On the contrary, in response to an occupant being not curious about a driving situation and performing his/her task, such as using a mobile phone, a confidence score of the corresponding occupant may become a score corresponding to confidence-secured section, and guidance may be minimized such that the occupant may concentrate on the task.

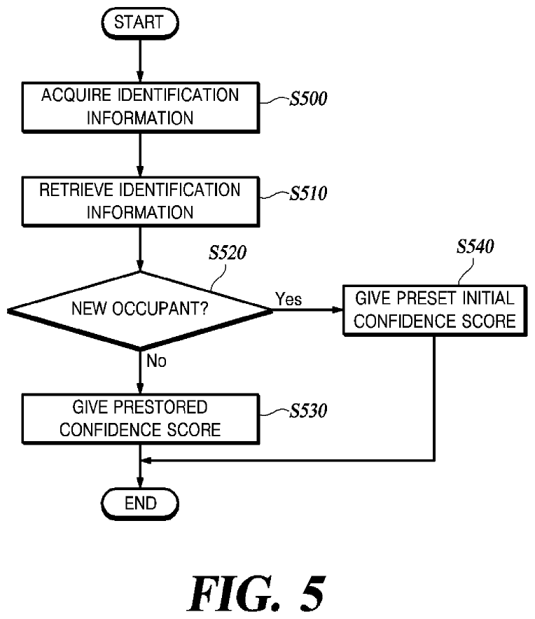

FIG. 5 is a flowchart illustrating a method for giving an initial confidence score to an occupant according to an exemplary embodiment of the present disclosure.

In response to an occupant getting in a vehicle 10 or calling the vehicle 10 outside the vehicle 10, the device for providing an HMI mode acquires identification information of the occupant from an occupant identification unit 100 and/or an occupant terminal 12 (S500).

The device for providing an HMI mode retrieves whether information matching the identification information of the occupant is stored in a storage 160 and/or a server 14 (S510). For example, the device for providing an HMI mode retrieves whether there is information matching the identification information of the occupant among pieces of personal information for each of the one or more occupants prestored in the storage 160 and/or the server 14.

The device for providing an HMI mode retrieves whether the occupant is a new occupant based on whether the information matching the identification information of the occupant is stored in the storage 160 and/or the server 14 (S520). Here, the new occupant may mean an occupant who gets in a vehicle, in which the device for providing an HMI mode is mounted, for the first time.

In response to determining that the occupant is not the new occupant, the device for providing an HMI mode gives a confidence score, which is stored in the storage 160 and/or the server 14 by matching the personal information of the occupant, to the occupant (S530).

On the contrary, in response to determining that the occupant is the new occupant, the device for providing an HMI mode gives a preset initial confidence score (for example, 50 points) to the occupant (S540).

Although operations are illustrated in FIGS. 3 to 5 as being sequentially performed, this is merely an exemplary description of the technical idea of one embodiment of the present disclosure. In other words, those skilled in the art to which one embodiment of the present disclosure belongs may appreciate that various modifications and changes can be made without departing from essential characteristics of one embodiment of the present disclosure, that is, the sequence illustrated in FIGS. 3 to 5 can be changed and one or more operations of the operations can be performed in parallel. Thus, FIGS. 3 to 5 are not limited to the temporal order.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Various embodiments of systems and techniques described herein can be realized by a programmable computer. Here, the computer includes a programmable processor, a data storage system (including a volatile memory, a non-volatile memory, another type of storage system, or a combination thereof), and at least one communication interface. For example, the programmable computer may be one of a server, a network device, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the present disclosure. Therefore, exemplary embodiments of the present disclosure have been described for the sake of brevity and clarity. The scope of the technical idea of the present embodiments is not limited by the illustrations. Accordingly, one of ordinary skill would understand the scope of the present disclosure is not to be limited by the above explicitly described embodiments but by the claims and equivalents thereof

What is claimed is:

1. A method for providing a human-machine-interface (HMI) mode, the method comprising:
analyzing, by a device of a vehicle, a state of an occupant;
calculating, by the device of the vehicle, a confidence score for the vehicle based on the state of the occupant;
determining, by the device of the vehicle, an HMI mode corresponding to the confidence score among a plurality of predefined HMI modes; and
providing, by the device of the vehicle, first guidance information to the occupant based on the determined HMI mode.

2. The method of claim 1, wherein the plurality of HMI modes include one or more of a maximum guidance mode, an intermediate guidance mode, or a minimum guidance mode,
wherein the maximum guidance mode corresponds to the confidence score which is less than or equal to a preset first threshold;
wherein the intermediate guidance mode corresponds to the confidence score which is greater than the first threshold and less than or equal to a preset second threshold; and
wherein the minimum guidance mode corresponds to the confidence score which is greater than the second threshold.

3. The method of claim 1, wherein the analyzing of the state of the occupant includes analyzing the state of the occupant at a time at which second guidance information is provided to the occupant.

4. The method of claim 3, wherein the confidence score is calculated based on at least one of whether the second guidance information is provided to the occupant, the state of the occupant analyzed at the time at which the second guidance information is provided to the occupant, or an HMI mode corresponding to the second guidance information.

5. The method of claim 1, wherein the calculating of the confidence score includes:
giving an initial confidence score to the occupant; and
updating the confidence score based on the state of the occupant.

6. The method of claim 5, wherein the updating of the confidence score includes:
in response to the occupant gazing outside or being curious about a driving situation of the vehicle, decreasing the confidence score; and
in response to the occupant performing a task or not gazing outside, increasing the confidence score.

7. The method of claim 5, wherein the updating of the confidence score includes:
in response to the occupant gazing outside or being curious about a driving situation of the vehicle even though second guidance information is not provided to the occupant, decreasing the confidence score; and
in response to the occupant performing a task or not gazing outside after the second guidance information is provided to the occupant, increasing the confidence score.

8. The method of claim 5, wherein the updating of the confidence score includes:
in response to the occupant gazing outside or being curious about a driving situation of the vehicle after second guidance information is provided to the occupant in a minimum guidance mode, decreasing the confidence score; and
in response to the occupant performing a task or not gazing outside after the second guidance information is provided to the occupant in a maximum guidance mode or an intermediate guidance mode, increasing the confidence score.

9. The method of claim 5, wherein the updating of the confidence score includes:
in response to the occupant gazing outside or being curious about a driving situation of the vehicle after second guidance information is provided to the occupant in a maximum guidance mode or an intermediate guidance mode, keeping the confidence score to be unchanged; and
in response to the occupant performing a task or not gazing outside after the second guidance information is provided to the occupant in a minimum guidance mode, keeping the confidence score to be unchanged.

10. The method of claim 5, wherein the updating of the confidence score includes:
changing a weight by which the confidence score is increased or decreased according to an HMI mode.

11. The method of claim 10, wherein the changing of the weight by which the confidence score is increased or decreased according to the HMI mode includes:
in response to the occupant gazing outside or being curious about a driving situation of the vehicle after second guidance information is provided to the occupant in a maximum guidance mode or an intermediate guidance mode, decreasing the confidence score by a first amount; and
in response to the occupant performing a task or not gazing outside after the second guidance information is provided to the occupant in the maximum guidance mode or the intermediate guidance mode, increasing the confidence score by a second amount which is greater than the first amount.

12. The method of claim 10, wherein the changing of the weight by which the confidence score is increased or decreased according to the HMI mode includes:
in response to the occupant performing a task or not gazing outside after second guidance information is provided to the occupant in a minimum guidance mode, increasing the confidence score by a first amount; and
in response to the occupant gazing outside or being curious about a driving situation of the vehicle after the second guidance information is provided to the occupant in the minimum guidance mode, decreasing the confidence score by a second amount which is greater than the first amount.

13. The method of claim 5, wherein the giving of the initial confidence score includes:
acquiring identification information of the occupant;
retrieving personal information matching the identification information of the occupant among a plurality of prestored personal information; and
giving a confidence score, which is mapped to the retrieved personal information, to the occupant as the initial confidence score.

14. The method of claim 5, wherein the giving of the initial confidence score includes giving a preset initial confidence score to the occupant as the initial confidence score.

15. An device for providing a human-machine-interface (HMI) mode, the device comprising:
a controller configured to analyze a state of an occupant, to calculate a confidence score for a vehicle based on the state of the occupant, to determine an HMI mode corresponding to the confidence score among a plurality of predefined HMI modes, and to provide first guidance information to the occupant based on the determined HMI mode.

16. The device of claim 15, wherein the controller is configured to:
analyze the state of the occupant at a time at which second guidance information is provided to the occupant.

17. The device of claim 16, wherein the confidence score is calculated based on at least one of whether the second guidance information is provided to the occupant, the state of the occupant analyzed at the time at which the second guidance information is provided to the occupant, or an HMI mode corresponding to the second guidance information.

18. The device of claim 15, wherein the controller is configured to:
give an initial confidence score to the occupant; and
update the confidence score based on the state of the occupant.

19. The device of claim 18, wherein the controller is configured to:
in response to the occupant gazing outside or being curious about a driving situation of the vehicle, decrease the confidence score; and
in response to the occupant performing a task or not gazing outside, increase the confidence score.

20. A vehicle for providing a human-machine-interface (HMI) mode, comprising a controller configured to analyze a state of an occupant, to calculate a confidence score for a vehicle based on the state of the occupant, to determine an HMI mode corresponding to the confidence score among a plurality of predefined HMI modes, and to provide first guidance information to the occupant based on the determined HMI mode.
